(19) United States
(12) Patent Application Publication
(10) Pub. No.: US 2012/0166627 A1
(43) Pub. Date: Jun. 28, 2012

(54) MONITORING AND MANAGING A HTTP SESSION INDEPENDENT OF CLIENT AND SERVER CONFIGURATIONS

(76) Inventors: Stephen Kraiman, Doylestown, PA (US); Eric Malmstrom, Beaverton, OR (US)

(21) Appl. No.: 12/979,982

(22) Filed: Dec. 28, 2010

(51) Int. Cl. G06F 15/173

(52) U.S. Cl. 709/224

(57) ABSTRACT

Methods and apparatuses for monitoring the state of a HTTP session between a client and a server and managing the session utilizing a session server independent of the client or server configurations are provided. Using the session information gathered from the session server, system resources that may have been reserved for quality of service considerations can be released independent of client or server configurations. The method and apparatuses disclosed can be used for HTTP streaming of live broadcasts or prerecorded content, for example.

### TECHNICAL FIELD

This disclosure relates to HTTP sessions.

### BACKGROUND

The Hypertext Transfer Protocol (HTTP) can be used to offer services such as video, voice, and high-speed Internet, for example, over a networked environment. For example, referring to FIG. 1, a service provider 110 can deliver a service or resource (hereinafter, “resource”) that can be stored on a server 110a, for example, over a network 130 to an end user 120 via a client 120a using the HTTP protocol.

Pursuant to the HTTP protocol, the server 110a can deliver the resource to the client 120a via a series of requests and responses. That is, to receive a resource from server 110a, the client 120a can connect to the server 110a, typically using a URL (Uniform Resource Locator, e.g., http://www.server110a.com/service.htm), and then submit a HTTP request message to the server 110a to request the resource. The server 110a then can send a response message to the client 120a containing the requested resource.

An HTTP session is a series of related request-response exchanges between the client 120a and server 110a. The HTTP protocol does not require that the client 120a or server 110a retain information about each request-response transaction of a HTTP session nor does the HTTP protocol require that the client 120a or server 110a retain information about the state of a HTTP session. Furthermore, the HTTP protocol does not require that the client 120a or server 110a identify a request-response transaction as belonging to a particular HTTP session. Thus, the server 110a can process each request-response transaction as an independent single request-response transaction HTTP session. In this way, the state of an HTTP session between a client and server can be unknown. Accordingly, the HTTP protocol can be referred to as a stateless protocol.

Techniques for monitoring an HTTP session (e.g., tracking each request-response transaction of a HTTP session, identifying a request-response transaction as belonging to a particular HTTP session, or retaining information about the state of a HTTP session) have been developed. These techniques involve the server 110a generating a unique session identifier (session ID) upon receiving a first request from the client 120a. The session ID is then used by the client 120a in subsequent request messages for the HTTP session. In this way, the server 110a can track the requests of a client 120a and monitor the HTTP session.

Each of the existing methods for monitoring HTTP sessions involves configuring the client and server, for example, to operate on a session ID as described above. However, it may not be possible to configure a client or server to monitor HTTP sessions. Accordingly, there is a need for methods and apparatuses to monitor HTTP sessions independent of client and server configurations.

### BRIEF DESCRIPTION OF THE DRAWINGS

FIG. 1 illustrates an example networked environment for delivering resources between a client and server.

FIG. 2 illustrates an example system for monitoring a HTTP session between a client and a server by utilizing a session server.

FIGS. 3A-C illustrate example processes for the example system of FIG. 2 for monitoring a HTTP session.

FIG. 4 illustrates another example networked environment for delivering resources between a client and server.

FIG. 5 illustrates an example process for managing a session between a client and a server by utilizing a session server.

FIGS. 6A-C illustrate example processes for the example system of FIG. 4 for managing a HTTP session.

FIG. 7 illustrates an example broadband communications device operable to perform the example processes of FIGS. 3A-C, 5, and 6A-C.

### DETAILED DESCRIPTION

Various implementations of this disclosure monitor and manage a HTTP session between a client and a server utilizing a session server independent of the client or server configurations.

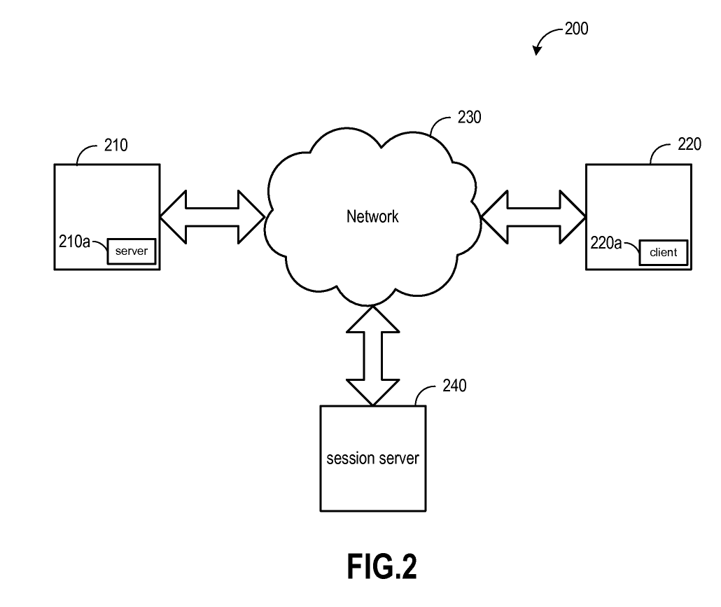

FIG. 2 illustrates an example system 200 for monitoring a HTTP session between a client and a server by utilizing a session server. The server 210a can provide a resource over a network 230 to a client 220a using the HTTP protocol. Session server 240 can be provided to monitor HTTP sessions between the client 220a and server 210a.

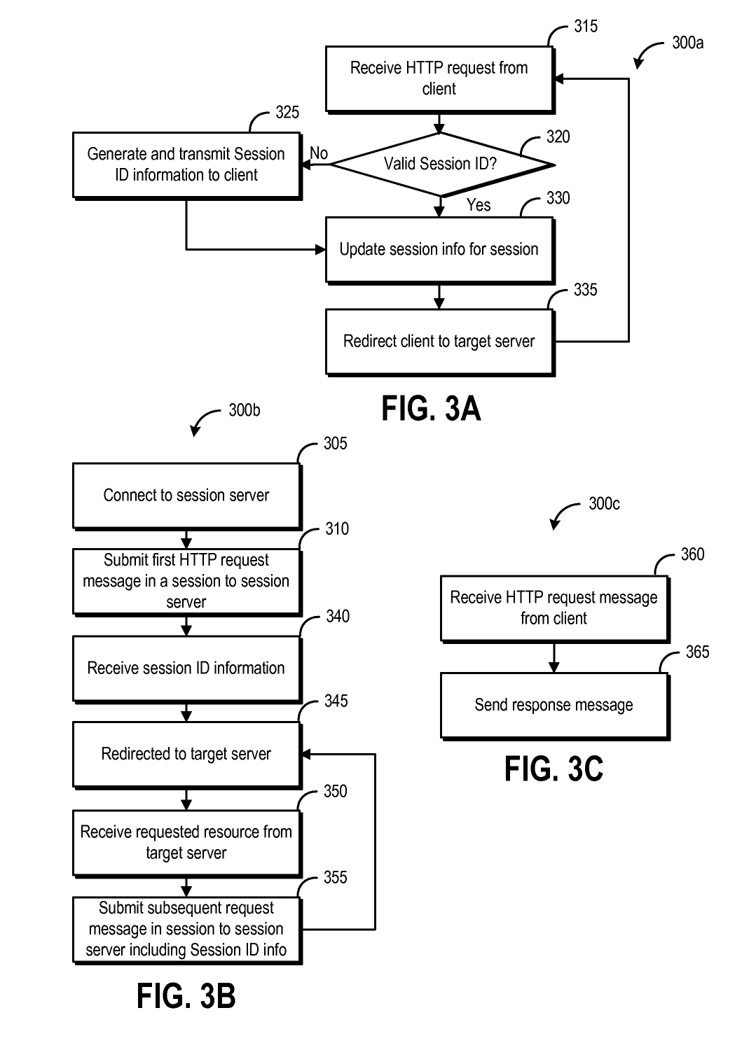

FIGS. 3A-C illustrate example processes 300a-c for the session server 240, client 220a, and server 210a of the example system of FIG. 2, respectively, for monitoring the state of a HTTP session between the client 220a and the server 210a utilizing the session server 240. While processes are illustrated in a particular order, such processes may not be required to be performed in the particular order shown or in sequential order.

At stage 305, the client 220a can connect to the session server 240 using, for example, a URL for the session server 240.

At stage 310, the client 220a submits a first HTTP request message (e.g., an HTTP GET request) to the session server 240. The HTTP request message can include a request for resources located on the server 210a. For example, assume the URL for session server 240 is www.sessionserver240.com. A client 220a can create a TCP connection to port 80 of the session server 240 (i.e., www.sessionserver.com) and send a HTTP GET request to session server 240 that includes the following lines to retrieve the resource “example.html”:

GET /example.html HTTP/1.1

Host: www.sessionserver240.com

At stage 315, the session server 240 receives the HTTP request message from the client 220a, and at stage 320, the session server 240 determines whether valid information uniquely identifying a session (i.e., session ID information) is included with the request message received at stage 315. There are existing methods for including session ID information in a request message. For example, session ID information can be included as a parameter in a HTTP GET or POST command or included in a HTTP cookie. One of ordinary skill in the art would know how to include session ID information in a request message at a client and determine whether session ID information is included in a request message at a server. This disclosure is not limited to any particular method of including or checking session ID information in a request message. The processes 300a-c can be implemented with any existing or later developed method for including or checking session ID information in a request message.

If the request message does not include valid session ID information (i.e., “No” at stage 320), then at stage 325, the session server 240 generates and transmits session ID information to the client 220a to be used by the client 220a in subsequent request messages for the session. A request message may not include valid session ID information because, for example, either the request message includes no session ID information or includes session ID information that the session server 240 cannot validate. For example, if a request message is a first request message of a session, then the request message may not include session ID information. As another example, a request message may include session ID information for a session that has expired. In this case, the session ID information can become invalid.

There are existing methods for generating and transmitting session ID information to a client. For example, the session server 240 can generate a random number to serve as the session ID information or a part thereof and send a HTTP cookie to the client 220a containing the session ID information. One of ordinary skill in the art would know how to generate and transmit session ID information to a client. This disclosure is not limited to any particular method of generating and transmitting session ID information. The processes 300a-c can be implemented with any existing or later developed method for generating and transmitting session ID information. The process 300a then proceeds to stage 330.

If the request message includes valid session ID information (i.e., “Yes” at stage 320), then at stage 330, using the session ID information, the session server 240 updates the session information for the session identified by the session ID information. The session information can be stored, for example, in a database on the session server 240 linked to the session ID information.

At stage 335, the session server 240 redirects the client 220a to the server 210a where the resource requested at stage 310 is located. There are numerous existing methods under the HTTP protocol for redirecting a client to another server. One of ordinary skill in the art would know how to redirect the client 220a to the server 210a where the resource requested at stage 310 is located. This disclosure is not limited to any particular method of redirection. The processes 300a-c can be implemented with any existing or later developed method for redirecting a client to another server.

The session server 240 can repeat stages 315-335 for each HTTP request received.

Returning to the client 220a, at stage 340, the client 220a can receive session ID information from the session server 240 to be used by the client 220a in subsequent request messages for the session. At stage 345, the client 220a is redirected to the server 210a where the resource requested at stage 310 is located, and at stage 350, the client 220a receives the requested resource. In some implementations, the session ID information received at stage 340 can be included in a response message redirecting the client to the server received at stage 345.

At stage 355, the client 220a submits subsequent request messages to the session server 240 requesting resources located on the server 210a. These subsequent request messages can include session ID information for the session. Stages 345-355 can be repeated for each request message in a session.

From the server 210a perspective, when the client 220a is redirected to server 210a at stage 345, the server 210a can receive at stage 360 a HTTP request message from the client 220a, for example, to retrieve the resource requested at stage 310 or stage 355. At stage 365, the server 210a can send a response message to the client 220a that can include the requested resource.

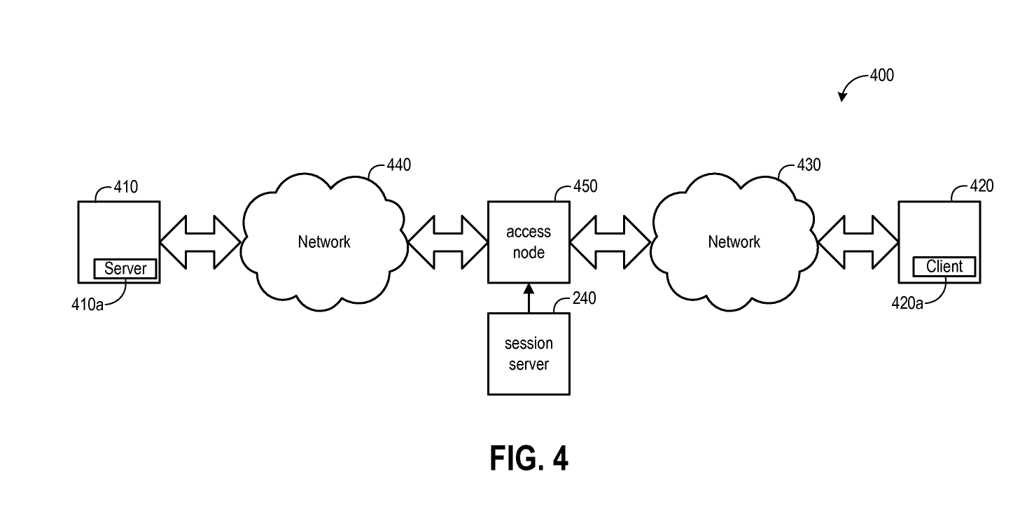

As shown in FIG. 4, typically, to deliver a service from a server 410a to a client 420a, the server 410a provides the service over a network 440 to an access node 450. The access node 450 then provides the service to the client 420a over a network 430. The network 430 can be any type of wired or wireless network. For example, the network 430 can take the form of an all-coax, all-fiber, or hybrid fiber/coax (HFC) network. This disclosure is not limited to any particular network.

In delivering a service to the client 420a, the access node 450 may reserve system resources (e.g., bandwidth) and/or control scheduling priorities to guarantee a certain quality of service (e.g., data rate, delay, latency, jitter). The client 420a or the session server 240 may request a certain quality of service. Typically, the system resources reserved during a session are not released until the access node 450 receives an external message from an external device such as the client 420a, for example, when the session has ended. However, a session may contain periods of inactivity when the system resources reserved for the session can be released and made available for other sessions, for example. However, the client 420a or server 410a may not send a message to the access node 450 to end a session during periods of inactivity. Accordingly, it can be desirable for the access node 450 to be able to release the system resources reserved for a session during periods of inactivity independent of the client 420a or server 410a.

The session server 240 of FIG. 2 can be used to monitor the session between the client 420a and the server 410a as described above with respect to FIGS. 2 and 3. The session server 240 can send a message to the access node 450 to release system resources when there is a period of inactivity. In this way, sessions can be managed independent of the client 420a or server 410a configurations. That is, instead of the client 420a or server 410a controlling a session (e.g., determining when to end a session), the session server 240 or another device using the information gathered from the session server 240 can control the session.

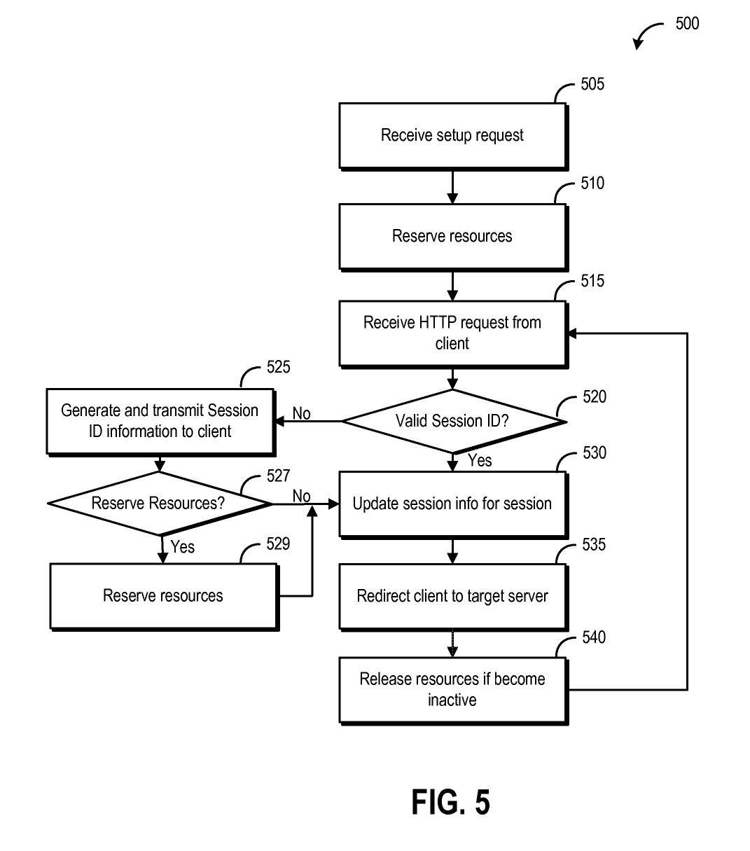

FIG. 5 illustrates an example process 500 for managing a session (e.g., by reserving and releasing resources) between the client 420a and the server 410a by utilizing the session server 240.

At stage 505, the access node 450 receives a request to create a session with a certain quality of service. In some implementations, the request can come from the client 420a or session server 240. At stage 510, the access node 450 can reserve resources to guarantee the requested quality of service. At stage 515, the session server 240 receives a HTTP request message from the client 420a, and at stage 520, the session server 240 determines whether valid information uniquely identifying a session (i.e., session ID information) is included with the request message received at stage 515.

If the request message includes valid session ID information (i.e., “Yes” at stage 520), then at stage 530, using the session ID information, the session server 240 updates the session information for the session identified by the session ID information.

At stage 535, the session server 240 redirects the client 220a to the target server 210a where the resource requested at stage 510 is located.

At stage 540, the session server 240 can send a message to the access node 450 to release reserved resources if the state of the session is deemed inactive based on the session information collected at stage 530. For example, if the session server 240 has not received an HTTP request after a certain elapsed time based on the time of the last received request, then the session server 240 can deem the session inactive and expire the session ID information for the session.

Returning to stage 520, if the request message does not include valid session ID information (i.e., “No” at stage 520), then at stage 525, the session server 240 can generate and transmit session ID information to the client 420a to be used by the client 420a in subsequent request messages for the session.

The session server 240 may receive a request message containing invalid session ID information if the session server 240 deemed the session inactive at stage 540 and then received an HTTP request from the client 420a that included the expired session ID information at stage 515. At stage 527, the session server 240 can determine whether the access node 450 should reserve resources to guarantee a previously requested quality of service. For example, if the expired session ended due to a determination by the session server 240 and not based on a message from the target server 410a or the client 420a, then the session server 240 can determine that the expired session should be reactivated with the same quality of service.

If the session server 240 determines that the access node 450 should reserve resources (“Yes” at stage 527), then at stage 529, the access node 450 can reserve resources to guarantee the previously requested quality of service. The process 500 then proceeds to stage 530. If the session server 240 determines that the access node 450 should not reserve resources (“No” at stage 527), then the process 500 proceeds to stage 530.

The session server 240 can repeat stages 515-540 for each HTTP request received.

It has been proposed for HTTP streaming of live broadcasts or prerecorded content (i.e., Video on Demand) to first segment a multimedia presentation into a series of short media files where each media file is placed on a server (e.g., server 210a) and each media file is identified by a URL. An index file that contains the list of media files for the multimedia presentation is also stored on the server. The index file also is identified by a URL. To play the multimedia presentation, it has been proposed that a client (e.g., client 220a) first obtain the index file from the server via its URL and then obtain from the server and play each media file in the index file.

Streaming media typically requires a certain level of quality of service. Thus, system resources can be reserved for the delivery of streaming media including HTTP streaming of live broadcasts or prerecorded content. Typically, the system resources reserved during a session between a client (e.g., client 420a) and server (e.g., server 410a) are not released until the client or the server sends a message that the session has ended. However, a session may contain periods of inactivity when the system resources reserved for the session can be released and made available for other sessions, for example. However, the client or server may not send a message to end a session during periods of inactivity or when a session has concluded (e.g., when all the media files for the presentation have been downloaded). Accordingly, it can be desirable to be able to independently release the system resources reserved for a session between the client and the server during periods of inactivity. The proposed implementation described above for HTTP streaming of live broadcasts or prerecorded content does not facilitate the independent monitoring and control of sessions and release of system resource when needed.

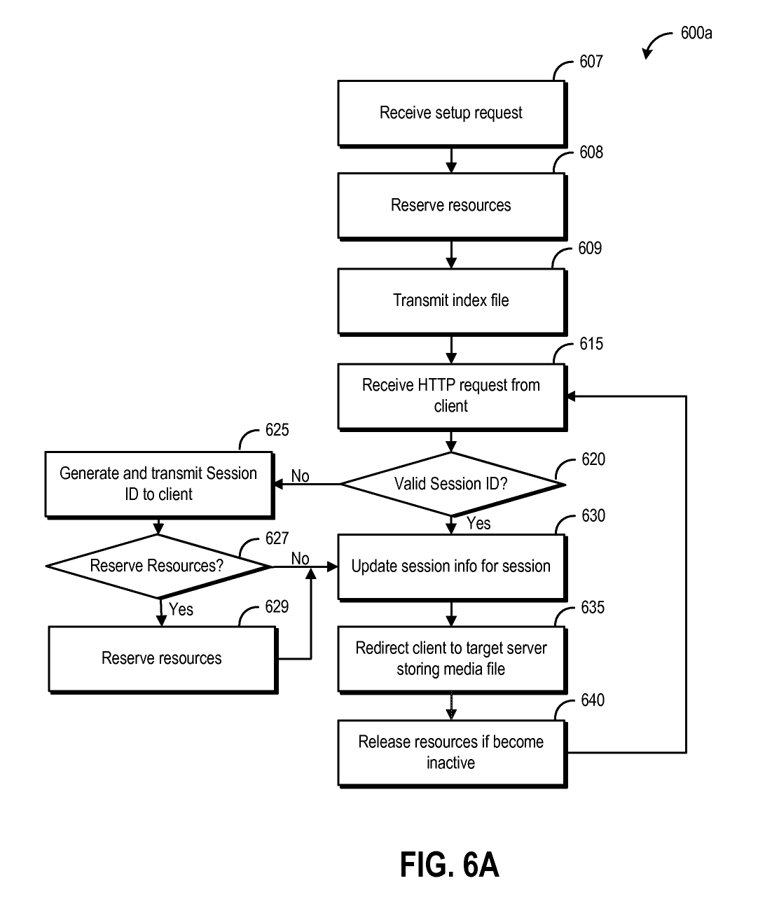

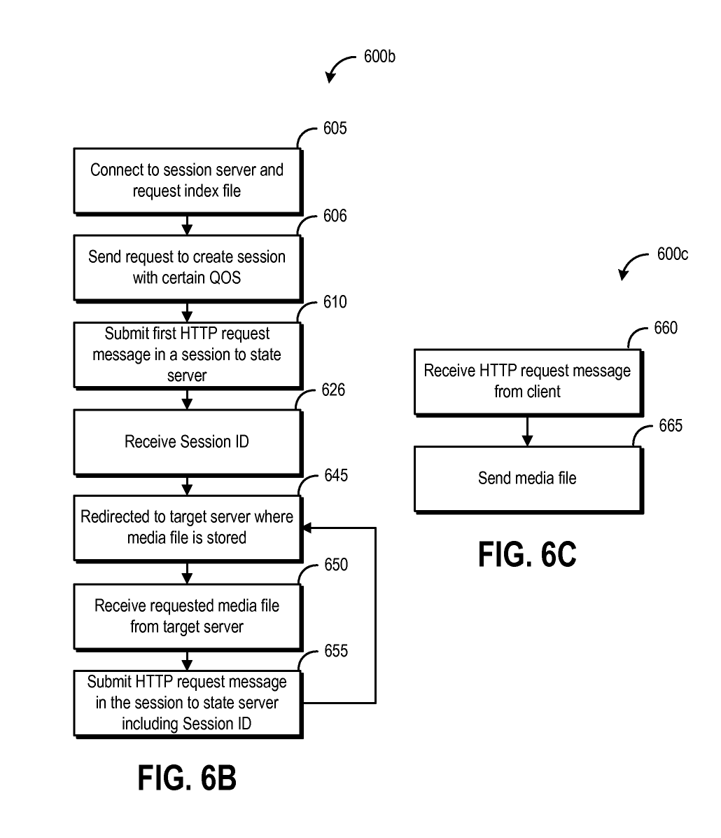

FIGS. 6A-C illustrate an implementation of the example processes 500, 300b, and 300c for HTTP streaming of live broadcasts or prerecorded content. More specifically, FIGS. 6A-C illustrate example processes 600a-c for the session server 240, client 420a, and server 410a of the example system of FIG. 4, respectively, for managing a HTTP streaming session (e.g., by reserving and releasing resources) between the client 420a and the server 410a by utilizing the session server 440.

In some implementations, to provide HTTP streaming of live broadcasts or prerecorded content and independently monitor and control sessions by releasing system resources when needed, a multimedia presentation is segmented into a series of short media files where each media file is placed on server 410a and identified by a URL. For each media file on server 410a, a link is created on the session server 240 to the media file. An index file that contains a list of the links on the session server 240 to the media files on server 410a is stored on the session server 240 and identified by a URL.

To play the multimedia presentation, the client 220a first obtains the index file from the session server 240 via its URL, for example, and then can subsequently follow each link in the index file. When the client 220a accesses a link, session server 240 redirects the client 220a to the media file on server 410a. The client 220a then obtains from the server 220a and plays the media file. By having the client 220a connect to the session server 240 first, the session server 240 can monitor or track the state of the session between the client 420a and the server 410a and send a message to release system resources when there is a period of inactivity.

More specifically, referring to FIGS. 6A-C, for HTTP streaming of live broadcasts or prerecorded content, at stage 605, the client 420a can connect to the session server 240 using, for example, a URL for the session server 240 and then submits a HTTP request message to request an index file for a multimedia presentation.

At stage 606, the client 220a can send a request to create a session with a certain quality of service to the session server 240, for example. In some implementations, the client 220a can send a request to create a session to the session server 240 and the session server 240 can determine the quality of service.

At stage 607, the access node 450 receives the request to create a session with a certain quality of service from the session server 240. In some implementation, the access node 450 can receive the request to create a session with a certain quality of service from the client 420a. At stage 608, the access node 450 can reserve resources to guarantee the requested quality of service.

At stage 609, the session server 240 can transmits to client 420a the index file stored on the session server 240 for the desired multimedia presentation. Based on the list of links in the index file, at stage 610, the client 420a submits a HTTP request message (e.g., an HTTP GET request) to the session server 240. At stage 615, the session server 240 receives the HTTP request message from the client 420a, and at stage 620, the session server 240 determines whether valid session ID information is included with the request message received at stage 615.

If the request message includes valid session ID information (i.e., “Yes” at stage 620), then at stage 630, using the session ID information, the session server 240 updates the session information for the session identified by the session ID information.

At stage 635, the session server 240 redirects the client 220a to the server 410a where the media file requested at stage 610 is located.

At stage 640, the session server 240 can send a message to the access node 450 to release reserved resources if the state of the session becomes inactive based on the session information collected at stage 630. For example, if the session server 240 has not received an HTTP request after a certain elapsed time based on the time of the last received request, then the session server 240 can deem the session inactive and expire the session ID information for the session.

Returning to stage 620, if the request message does not include valid session ID information (i.e., “No” at stage 520), then at stage 625, the session server 240 can generate and transmit session ID information to the client 420a to be used by the client 420a in subsequent request messages for the session.

The session server 240 may receive a request message containing invalid session ID information if the session server 240 deemed the session inactive at stage 640 and then received an HTTP request from the client 620a that included the expired session ID information at stage 615. At stage 627, the session server 240 can determine whether the access node 450 should reserve resources to guarantee a previously requested quality of service. For example, if the expired session ended due to a determination by the session server 240 and not based on a message from the server 410a or the client 420a, then the session server 240 can determine that the expired session should be reactivated with the same quality of service.

If the session server 240 determines that the access node 450 should reserve resources (“Yes” at stage 627), then at stage 629, the access node 450 can reserve resources to guarantee the previously requested quality of service. The process 600a then proceeds to stage 630. If the session server 240 determines that the access node 450 should not reserve resources (“No” at stage 627), then the process 600a proceeds to stage 330.

The session server 240 can repeat stages 615-640 for each HTTP request received.

Returning to the client 420a, at stage 626, the client 420a can receive session ID information to be used by the client 420a in subsequent request messages for the session. At stage 645, the client 420a is redirected to the server 210a where the media file requested at stage 610 is located, and at stage 650, the client 420a receives the requested media file. In some implementations, the session ID information received at stage 626 can be included in a response message redirecting the client to the server received at stage 645.

At stage 655, the client 420a submits subsequent HTTP request messages to the session server 240 to request additional media files located on the server 410a for the multimedia presentation. These subsequent HTTP request messages can include the session ID for the session. Stages 645-655 can be repeated for each HTTP request message in a session.

From the server 410a perspective, when the client 420a is redirected to server 410a at stage 645, the server 410a can receives at stage 460, a HTTP request message from the client 420a to retrieve the media file requested at stage 610 or stage 655. At stage 665, the server 410a can send a response message to client 420a that can include the requested media file.

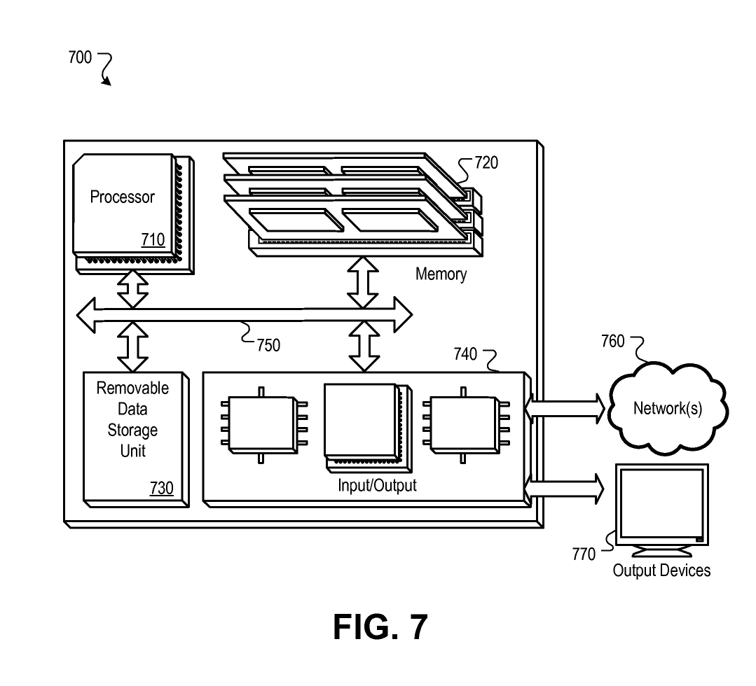

FIG. 7 illustrates an example session server 240, target server 210a, 410a, or client 220a, 420a operable to perform the example process 300a, 300b, or 300c of FIGS. 3A-C or process 500 of FIG. 5 or process 600a, 600b, or 600c of FIGS. 6A-C.

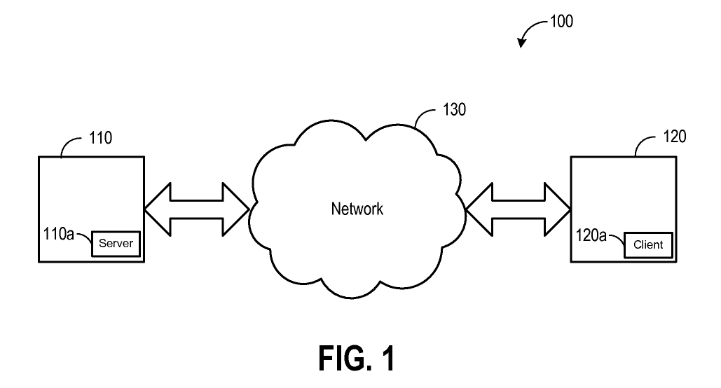

The session server 240, server 210a, 410a, or client 220a, 420a can include a processor 710, a memory 720, a removable data storage unit 730, and an input/output device 740. Each of the components 710, 720, 730, and 740 can, for example, be interconnected using a system bus 750. The processor 710 is capable of processing instructions for execution within the session server 240, server 210a, 410a, or client 220a, 420a. For example, the processor 710 can be capable of processing instructions for executing the process 300a, 300b, or 300c of FIG. 1 or process 500 of FIG. 5 or process 600a, 600b, or 600c of FIG. 6 in session server 240, server 210a, 410a, or client 220a, 420a. In some implementations, the processor 710 is a single-threaded processor. In other implementations, the processor 710 is a multi-threaded processor. The processor 710 is capable of processing instructions stored in the memory 720 or on the storage device 730.

The memory 720 stores information within the session server 240, server 210a, 410a, or client 220a, 420a. For example, for session server 240, memory 720 may store the session information. In some implementations, the memory 720 is a computer-readable medium. In other implementations, the memory 720 is a volatile memory unit. In still other implementations, the memory 720 is a non-volatile memory unit.

Implementations of the device of this disclosure, and components thereof, can be realized by instructions that upon execution cause one or more processing devices to carry out the processes and functions described above. Such instructions can, for example, comprise interpreted instructions, such as script instructions, e.g., JavaScript or ECMAScript instructions, or executable code, or other instructions stored in a computer readable medium.

The processes and logic flows described in this specification can be performed by one or more programmable processors executing one or more computer programs to perform functions by operating on input data and generating output thereby tying the process to a particular machine (e.g., a machine programmed to perform the processes described herein). The processes and logic flows can also be performed by, and apparatus can also be implemented as, special purpose logic circuitry, e.g., an FPGA (field programmable gate array) or an ASIC (application specific integrated circuit).

Computer readable media suitable for storing computer program instructions and data include all forms of non volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD ROM disks. The processor and the memory can be supplemented by, or incorporated in, special purpose logic circuitry.

To provide for interaction with a user, implementations of the subject matter described in this specification can be operable to interface with a computing device having a display, e.g., a CRT (cathode ray tube) or LCD (liquid crystal display) monitor, for displaying information to the user and a keyboard and a pointing device, e.g., a mouse or a trackball, by which the user can provide input to the computer.

While this specification contains many specific implementation details, these should not be construed as limitations on the scope of any invention or of what may be claimed, but rather as descriptions of features that may be specific to particular implementations of particular inventions. Certain features that are described in this specification in the context of separate implementations can also be implemented in combination in a single implementation. Conversely, various features that are described in the context of a single implementation can also be implemented in multiple implementations separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the implementations described above should not be understood as requiring such separation in all implementations, and it should be understood that the described program components and systems can generally be integrated together in a single software product or packaged into multiple software products.

Particular implementations of the subject matter described in this specification have been described. Other implementations are within the scope of the following claims. For example, the actions recited in the claims can be performed in a different order and still achieve desirable results, unless expressly noted otherwise. As one example, the processes depicted in the accompanying figures do not necessarily require the particular order shown, or sequential order, to achieve desirable results. In some implementations, multitasking and parallel processing may be advantageous.

1. A method monitoring the state of a HTTP session between a client and a server utilizing a session server, the method comprising:
receiving a HTTP request message from a client requesting resources located on a target server wherein the HTTP request message includes session ID information;
updating session information for a session identified by the session ID information included with the HTTP request message; and
redirecting the client to the target server.

2. The method of claim 1 further comprising generating the session ID information and transmitting the session ID information to the client prior to the receiving step.

3. The method of claim 1 further comprising reserving system resources for the session identified by session ID information.

4. The method of claim 3 further comprising releasing the reserved system resources based on the session information obtained from the updating step.

5. The method of claim 4 wherein the reserved system resources are released if the session becomes inactive after a predetermined period of time.

6. The method of claim 1 further comprising transmitting to the client an index file including a list of media files stored on the target server for a multimedia presentation.

7. The method of claim 6 further wherein the requested resource is one of the media files of the list of media files included in the index file.

8. A computer readable medium having instructions for causing a computer to execute a method for monitoring the state of a HTTP session between a client and a server utilizing a session server, the method comprising:
receiving a HTTP request message from a client requesting resources located on a target server;
updating session information for a session identified by session ID information included with the HTTP request message; and
redirecting the client to the target server.

9. The computer readable medium of claim 8 wherein the method further comprises generating the session ID information and transmitting the session ID information to the client prior to the receiving step.

10. The computer readable medium of claim 8 wherein the method further comprises reserving system resources for the session identified by session ID information.

11. The computer readable medium of claim 8 wherein the method further comprises releasing the reserved system resources based on the session information obtained from the updating step.

12. The computer readable medium of claim 11 wherein the reserved system resources are released if the session becomes inactive after a predetermined period of time.

13. The computer readable medium of claim 8 wherein the method further comprises transmitting to the client an index file including a list of media files stored on the target server for a multimedia presentation.

14. The computer readable medium of claim 13 wherein the requested resource is one of the media files of the list of media files included in the index file.

15. A system for monitoring the state of a HTTP session between a client and a server utilizing a session server, the system comprising:
means for receiving a HTTP request message from a client requesting resources located on a target server wherein the HTTP request message includes session ID information;
means for updating session information for a session identified by the session ID information included with the HTTP request message; and
means for redirecting the client to the target server.
